(19) United States
(12) Patent Application Publication
(10) Pub. No.: US 2007/0242911 A1
(43) Pub. Date: Oct. 18, 2007

(54) Bearing mechanism and spindle motor having the same

(75) Inventors: Hisaya Nakagawa, Komagane-shi (JP); Michiaki Takizawa, Komagane-shi (JP); Toru Nakanishi, Komagane-shi (JP); Takeshi Kaneko, Komagane-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NIDEC CORPORATION, kyoto (JP)

(21) Appl. No.: 11/808,826

(22) Filed: Jun. 13, 2007

(30) Foreign Application Priority Data
Jan. 31, 2005 (JP) 2005-023134

(51) Int. Cl. F16C 33/02

(52) U.S. Cl. 384/279

(57) ABSTRACT

A bearing mechanism having a sleeve including at an inner circumferential surface thereof a first bearing surface and a relief portion including a diameter greater than that of the first bearing surface is used in a spindle motor. An axial length of the first bearing surface is between approximately 1.2 mm and 1.8 mm. By virtue of such configuration, characteristics of the spindle motor are improved and an operating life of the spindle motor is extended.

### BACKGROUND OF THE INVENTION

1. Field of the Invention

The present invention relates to a bearing mechanism and a spindle motor having the bearing mechanism for use in order to improve the characteristics of the spindle motor used in a disk driving device.

2. Description of the Related Art

Conventionally, a spindle motor is used in a disk driving device in order to rotate a storage medium (e.g., DVD and/or CD). As shown in FIG. 8A, a spindle motor 100 comprises a rotor 110 and a stator 120.

The rotor 110 includes a rotor case 111, a shaft 112 arranged at a central portion of the rotor case 111, and a rotor magnet 113 arranged at an outer circumferential portion of the rotor case 111. The stator 120 includes a stator core 121 arranged opposing to the rotor magnet 113, a bearing mechanism 122 for rotatably supporting the shaft 112, a bearing holder 123 for retaining the bearing mechanism 122, and a base plate 124 for fixing the bearing holder 123.

FIG. 8B is an enlarged view of the bearing mechanism 122 shown in FIG. 8A.

As shown in FIG. 8B, the bearing mechanism 122 includes a sleeve 122a for rotatably supporting the shaft 112, and a thrust bearing 122b for supporting a bottom end of the shaft 112. The sleeve 122a includes a first bearing surface 122c and a second bearing surface 122d. An outer circumferential surface of the shaft 112 is slidably supported by the first bearing surface 122c and the second bearing surface 122d. The sleeve 122a includes a relief portion 122e having a diameter greater than that of the first bearing surface 122c and that of the second bearing surface 122d. The shaft 112 makes no contact with the sleeve 122a at the relief portion 122e. The relief portion 122e is arranged at a mid way portion in an axial direction of an inner circumferential surface of the sleeve 122a.

However, the conventional bearing mechanism 122 has following problems.

An axial length L1 of the first bearing surface 122c is between approximately 2.5 mm to approximately 3.0 mm. With such configuration, however, frictional resistance imposed on the first bearing surface 122c is great, and therefore, a rate of rotation of the spindle motor 100 will be decreased and a value of electric current will be increased.

If the axial length L1 is shortened, an area of the first bearing surface 122c will be decreased, and consequently, frictional resistance imposed on the first bearing surface 122c will be reduced improving characteristic of the motor. However, if the length L1 is shortened excessively, metal-to metal contact between the shaft 112 and the first bearing surface 122c will be increased, and consequently, an operating life of the motor will be shortened.

On the other hand, an interval L3 between the rotor 110, which is fixed to the shaft 112, and a top surface of the sleeve 122a is less than approximately 1.0 mm. With such configuration, however, oil arranged near the first bearing surface 122c may adhere to the rotor 110 via an outer surface of the shaft 112. Also, the oil may be scattered due to centrifugal force generated by the rotor 110, thereby shortening the operating life of motor.

### SUMMARY OF THE INVENTION

A bearing mechanism according to a preferred embodiment of the present invention is used in a spindle motor for rotating a storage medium.

The bearing mechanism includes a shaft, and a sleeve whose inner circumferential surface is opposed to an outer circumferential surface of the shaft, wherein the sleeve relatively rotates with respect to and concentrically with the shaft.

The inner circumferential surface of the sleeve includes a first bearing surface, a second bearing surface and a relief portion arranged axially between the first bearing surface and the second bearing surface.

The first bearing surface has an axial length between approximately 1.2 mm and approximately 1.8 mm. The inner circumferential surface is such that a radius at the relief portion is greater than that at the first bearing surface and that at the second bearing surface.

According to the preferred embodiment of the present invention, a rate of rotation of the spindle motor is increased and a value of electric current is decreased. Also, according to the preferred embodiment of the present invention, a factor shortening an operating life of the motor will be minimized.

Also, an oil used in the motor as a lubrication fluid has a high viscosity thereby preventing the oil from being scattered and evaporated, and therefore the operating life of the motor will be extended.

The bearing mechanism according to the preferred embodiment of the present invention, the load generated by the shaft is not imposed on an entire bearing surface. The bearing mechanism is in a mixed lubrication state in which a film is appropriately formed on the oil thereby conducting hydrodynamic lubrication, and a film is not appropriately formed on the oil such that a portion of metallic components make contact with one another thereby conducting boundary lubrication.

By virtue of such configuration, the spindle motor having applied therein the bearing mechanism according to the preferred embodiment of the present invention rotates at high speed and the value of the electric current required to rotate the spindle motor is small, and therefore, the characteristics of the motor will be improved.

It is to be appreciated that a term “half height” means approximately 1.6 inch. Accordingly, when the bearing mechanism according to the preferred embodiment of the present invention is used in a spindle motor for use in a disk driving device, the characteristics of the motor are effectively improved and the operating life of the motor will be extended.

An axial length of the second bearing surface may be as long as the first bearing surface or longer or shorter than the first bearing surface.

According to the preferred embodiment of the present invention, hydrocarbon oil having viscosity between approximately 22 cst and approximately 46 cst at approximately 40° C. is provided at the space between aforementioned bearing surface and the shaft. By virtue of the characteristic of such oil, scattering, degradation and evaporation of the oil will be minimized and therefore, the operating life of the motor will be extended.

Compared with a conventional bearing mechanism using hydrocarbon oil having viscosity between approximately 17 cst and approximately 18 cst at approximately 40° C., the bearing mechanism according to preferred embodiment of the present invention is better able to minimize the scattering, degradation and evaporation of the oil.

Also, due to the high viscosity of the oil used therein, the shaft makes contact with the bearing surfaces via the oil film, and therefore, the area at which the boundary lubrication is conducted will be reduced and the operating life of the motor will be extended.

Other features, elements, steps, characteristics and advantages of the present invention will become more apparent from the following detailed description of preferred embodiments thereof with reference to the attached drawings.

### BRIEF DESCRIPTION OF THE DRAWINGS

FIG. 1 is a cross sectional view of a structure of a bearing mechanism according to a preferred embodiment of the present invention.

FIG. 2 is a flowchart illustrating a flow of steps for manufacturing a sleeve of the bearing mechanism according to the preferred embodiment of the present invention.

FIG. 3A is a graph showing a result of a performance test of the bearing mechanism according to the preferred embodiment of the present invention.

FIG. 3B is a graph showing a result of a performance test of the bearing mechanism according to the preferred embodiment of the present invention.

FIG. 3C is a table showing a result of a life evaluation test of the bearing mechanism according to the preferred embodiment of the present invention.

FIG. 4A is a graph showing a result of a performance test of the bearing mechanism according to the preferred embodiment of the present invention.

FIG. 4B is a graph showing a result of a performance test of the bearing mechanism according to the preferred embodiment of the present invention.

FIG. 4C is a table showing a result of a life evaluation test of the bearing mechanism according to the preferred embodiment of the present invention.

FIG. 5A is a graph showing a result of a performance test of the bearing mechanism according to the preferred embodiment of the present invention.

FIG. 5B is a graph showing a result of a performance test of the bearing mechanism according to the preferred embodiment of the present invention.

FIG. 6A is a graph showing a result of a performance test of the bearing mechanism according to the preferred embodiment of the present invention.

FIG. 6B is a graph showing a result of a performance test of the bearing mechanism according to the preferred embodiment of the present invention.

FIG. 7 is a table showing a result of a life evaluation test of the bearing mechanism according to the preferred embodiment of the present invention.

FIG. 8 is a cross sectional view of a conventional spindle motor and a conventional bearing mechanism.

### DETAILED DESCRIPTION OF PREFERRED EMBODIMENT

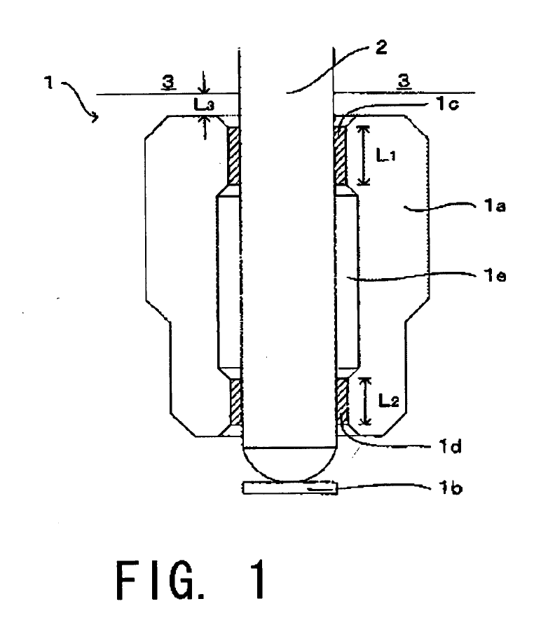

Hereinafter, a preferred embodiment of the present invention will be described with reference to FIGS. 1 to 7.

Note that in the description of the preferred embodiment of the present invention herein, words such as upper, lower, left, right, upward, downward, top, bottom for explaining positional relations between respective members and directions merely indicate positional relationships and directions in the drawings. Such words do not indicate positional relationships and directions of the members mounted in an actual device.

Also note that reference numerals, figure numbers and supplementary explanations are shown below for assisting the reader in finding corresponding components in the description of preferred embodiments below to facilitate the understanding of the present invention. It is understood that these expressions in no way restrict the scope of the present invention.

FIG. 1 is a diagram showing a cross sectional view of a bearing mechanism.

According to FIG. 1, the bearing mechanism 1 includes a sleeve la for rotatably supporting a shaft 2, and a thrust member 1b for supporting a bottom end of the shaft 2.

The sleeve 1a includes a first bearing surface 1c and a second bearing surface 1d with which the shaft 2 slidably contacts and on which radial load is imposed. Also, a relief portion 1e is arranged at a portion on an inner circumferential surface of the sleeve 1a at substantially a mid portion in an axial direction, wherein the inner diameter of the relief portion 1e is greater than that of the first bearing surface 1c and that of the second bearing surface 1d so as not to make contact with an outer circumferential surface of the shaft 2.

A radial bearing is formed by the outer circumferential surface of the shaft 2, the first bearing surface 1c and the second bearing surface 1d. The shaft 2 is rotatably and slidably supported by the first bearing surface 1c and the second bearing surface 1d. Also, a thrust bearing is formed by a bottom end of the shaft 2 and the thrust member 1b. The shaft 2 is rotatably and slidably supported by the thrust member 1b.

Hereinafter, according to the bearing mechanism 1 of the present preferred embodiment of the present invention, the first bearing surface 1c has an axial length, L1, between approximately 1.2 mm to approximately 1.8 mm, and the second bearing surface 1d has an axial length, L2, between approximately 1.2 mm to approximately 1.8 mm. As for oil, hydrocarbon oil having viscosity, VG, between approximately 22 cst and approximately 46 cst at approximately 40° C. is used. L3, a distance between a bottom surface of the rotor 3 fixed to the shaft 2 and a top surface of the sleeve 1a is greater than approximately 1.0 mm. A porous ratio of the first bearing surface 1c and that of the second bearing surface 1d are between approximately 5% and 15%.

The sleeve 1a is a porous member made by a process including a step in which powdered material is pressed in a mold, a step in which the mold is sintered, and a step in which the sintered material is again shaped in another mold for sizing.

A component ratio of the sleeve 1a according to the present preferred embodiment is as follows; iron approximately 70%, copper approximately 27%, tin approximately 3% and graphite approximately 1%). By the virtue of such ratio, abrasion quality and lubricity of the sleeve 1a will be improved, and thereby an operating life of the motor having therein the sleeve is extended. Note that, needless to say, the component ratio of the sleeve 1a may not limited thereto. The ratio may be as follows; iron (approximately 30% to approximately 70%), copper (approximately 30% to approximately 70%), tin (approximately 3% to approximately 7%) and graphite (approximately 0.3% to approximately 2%).

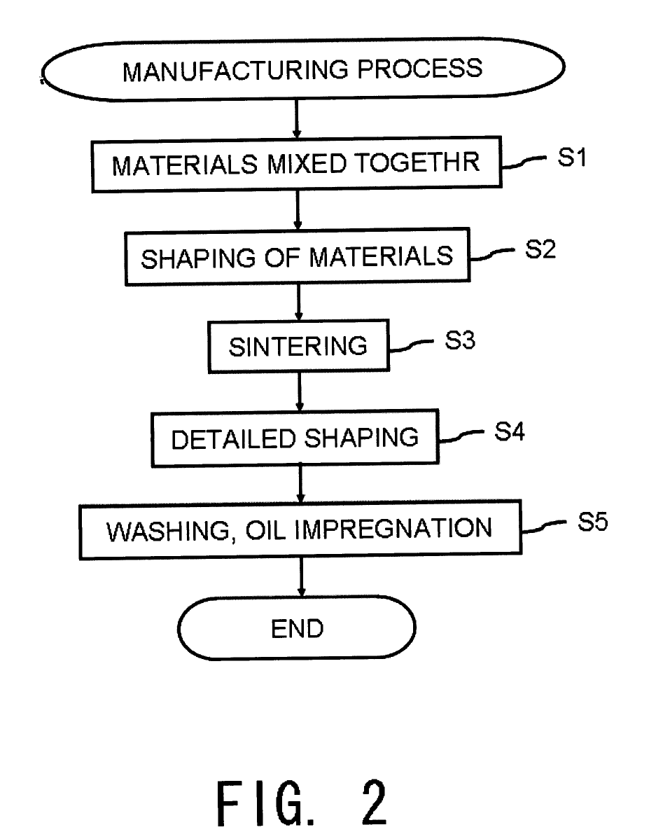

Next, steps involved in a manufacturing process of the bearing mechanism 1 according to the preferred embodiment of the present invention will be described. FIG. 2 is a flowchart illustrating a flow of steps for manufacturing the sleeve 1a of the bearing mechanism 1. Note that processes for manufacturing components such as thrust member 1b are widely known and therefore the descriptions thereof are omitted.

According to FIG. 2, materials required for the bearing mechanism 1 are mixed together (step S1) . In particular, for example, raw materials such as iron, copper and tin are mixed with solid lubricant such as graphite. Note that the graphite makes up between approximately 0.3% to approximately 2% of the materials used to make the sleeve 1a.

Next, the materials are placed in the mold so as to form a shape (step S2). In particular, the materials are formed such that a portion corresponding to the first bearing surface 1c has the axial length (L1) between approximately 1.2 mm and approximately 1.8 mm.

Next, the molded shape of the sleeve 1a is sintered at a predetermined temperature (e.g., approximately 800° C. to approximately 900° C.) (step S3). Note that the sintering does not need to be performed at a temperature high enough to fuse the materials. Also note that the no shot peening is required and therefore, the molded shape of the sleeve 1a can be modified. Also note that dissociated ammonia gas is used during this step.

Next, the molded shape of the sleeve 1a is recompressed (step S4). In particular, the molded shape of the sleeve 1a is recompressed such that a portion thereof corresponding to the second bearing surface 1d has the axial length (L2) between approximately 1.2 mm and approximately 1.8 mm. During this step, the first bearing surface 1c and the second bearing surface 1d are adjusted such that their porous ratio becomes between approximately 5% and approximately 15%. The shaping of the sleeve 1a is finalized during step S4.

Then finally, the sleeve 1a having the finalized shape is washed and the oil is supplied therein (step S5). In particular, the hydrocarbon oil having viscosity, VG, between approximately 22 cst and approximately 46 cst at approximately 40° C. is impregnated in the sleeve 1a.

The sleeve 1a formed as described above is operable to increase a rate of rotation of the spindle motor and decrease a value of electric current. Also, a factor shortening the operating life of the motor will be minimized. Also, the oil used has high viscosity thereby preventing the oil from being scattered and evaporated, and therefore the operating life of the motor will be extended.

Note that since the relief portion 1e is not recompressed, a surface of the relief portion 1e is highly porous. Also, compared with the surface of the relief portion 1e, the surface of the first bearing surface 1c and that of the second bearing surface 1d are relatively less porous, and therefore the characteristics of the motor are improved.

Further, since the axial length of the second bearing surface 1d is between approximately 1.2 mm and approximately 1.8 mm, frictional resistance imposed on the second bearing surface 1d will be reduced. By virtue of such configuration, the rate of rotation of the spindle motor will be increased and the value of the electric current will be decreased.

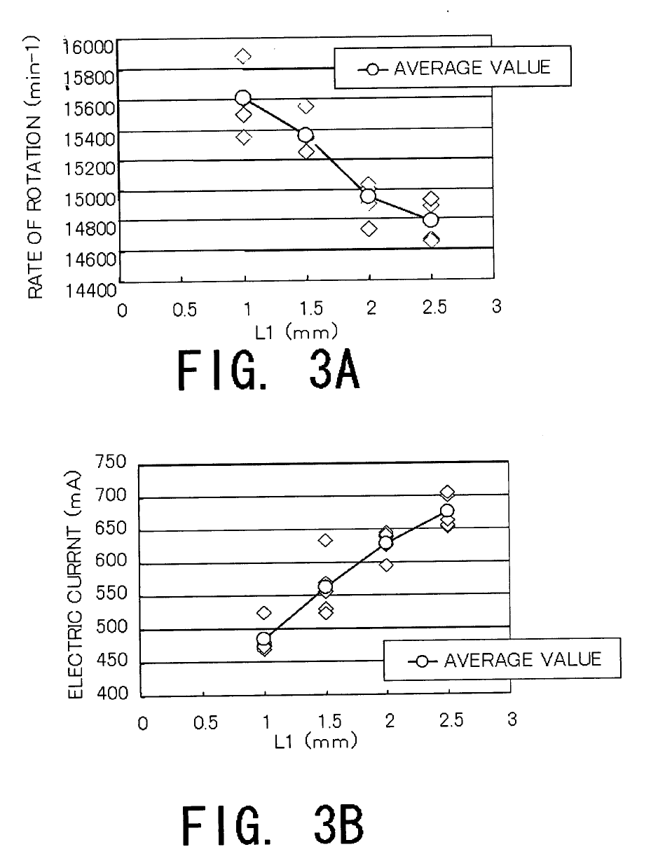

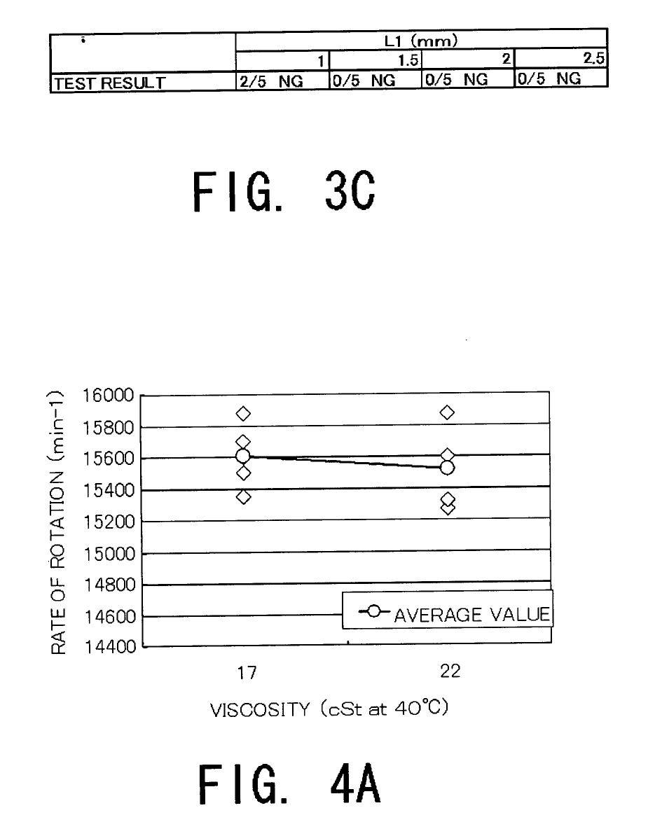

FIG. 3A and FIG. 3B each show a diagram showing a result of a performance test and a result of the life evaluation test performed on the bearing mechanism 1 according to the preferred embodiment of the present invention in order to examine initial characteristics of the bearing mechanism 1. The horizontal axis indicates the axial length (L1) of the first bearing surface 1c and the vertical axis indicates the rate of rotation of the spindle motor and the value of the electric current.

According to FIG. 3A, a line of a line graph shows smaller values toward the right hand side of the graph. This indicates that the shorter the axial length of the first bearing surface 1c, the greater the ratio of rotation of the motor becomes, which means that the characteristic of the motor is improved. According to FIG. 3B, a line of a line graph shows greater values toward the right hand side of the graph. This indicates that the shorter the axial length of the first bearing surface 1c, the smaller the value of electric current becomes which means that the characteristic of the motor is improved. FIG. 3C shows a diagram showing a result of the life evaluation test performed on the bearing mechanism according to the present preferred embodiment of the present invention. In particular, FIG. 3C indicates a frequency of bearing mechanism failing the life evaluation test at given porous ratio.

According to FIG. 3C, when the length of the first bearing surface 1c is 1 mm, two out of five bearing mechanisms failed the test. Also, when the length of the first bearing surface 1c is 1.5 mm, 2 mm, and 2.5 mm, none of the bearing mechanism failed the test. That is, when the axial length of the first bearing surface 1c is as short as 1 mm, the operating life of the motor may be shortened.

It is preferable that the axial length of the first bearing surface 1c is approximately 1.5 mm. Considering an instrumental error during a manufacturing process of the first bearing surface 1c, it is preferable that the axial length of the first bearing surface 1c is between approximately 1.2 mm and approximately 1.8 mm. As is evident from FIGS. 3A to 3C, the rate of rotation the spindle motor is increased and the value of the electric current is decreased depending on the axial length of the first bearing surface 1c and the second bearing surface 1d.

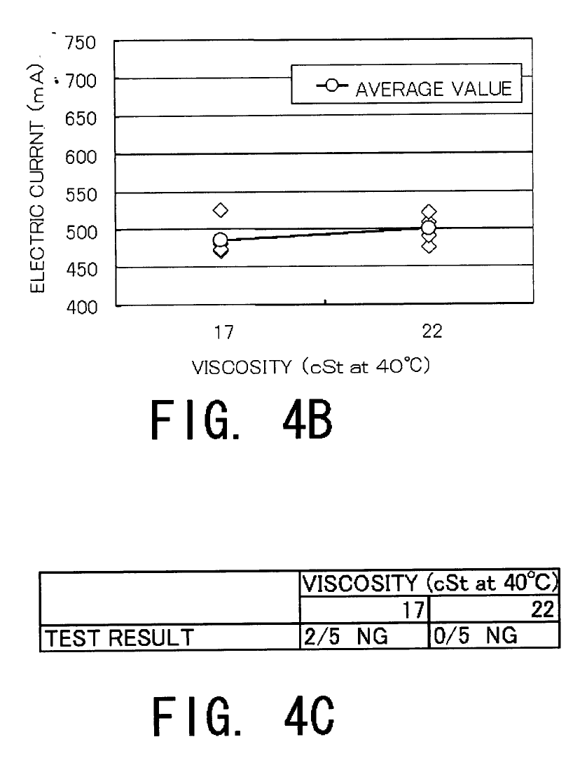

FIG. 4A and FIG. 4B each show a graph indicating a result of a performance test and that of the life evaluation test. FIG. 4A shows a correlation between the rate of rotation of the bearing mechanism 1 according to the preferred embodiment of the present invention and the viscosity (VG17 or VG22) of the oil used therein. FIG. 4B shows a correlation between the number of time the bearing mechanism 1 according to the preferred embodiment of the present invention rotates and the viscosity (VG17 or VG22) of the oil used therein.

According to FIG. 4A, a line showing an average value of the rate of rotation of the bearing mechanism 1 when oil having different viscosity is used is parallel to the horizontal axis. That is, regardless of the viscosity of the oil used therein, the rate of the rotation of the bearing mechanism remains unchanged and the performance of the motor is unaffected. According to FIG. 4B, a line showing an average value of the electric current of the bearing mechanism 1 when oil having different viscosity is used is parallel to the horizontal axis. That is, regardless of the viscosity of the oil used therein, the value of the electric current remains unchanged and the performance of the motor is unaffected.

FIG. 4C shows a result of the life evaluation test performed on the bearing mechanism 1 according to the present preferred embodiment of the present invention. In particular, FIG. 4C indicates a frequency of bearing mechanism failing the life evaluation test at given porous ratios. Note that the axial length of the first bearing surface 1c is 1 mm.

According to FIG. 4C, when a degree of viscosity of the oil used therein is 17, two out of five bearing mechanisms failed the life evaluation test, while a degree of viscosity of the oil used therein is 22, no bearing mechanism failed the life evaluation test. That is, when the degree of viscosity of the oil used therein is increased, the operating life of the motor is extended.

As described above, according to FIGS. 4A to 4C, when the degree of viscosity of the oil used therein is 22, the motor performs appropriately and the oil will neither be scattered, degraded, nor evaporated, and therefore, the operating life of the motor will be extended.

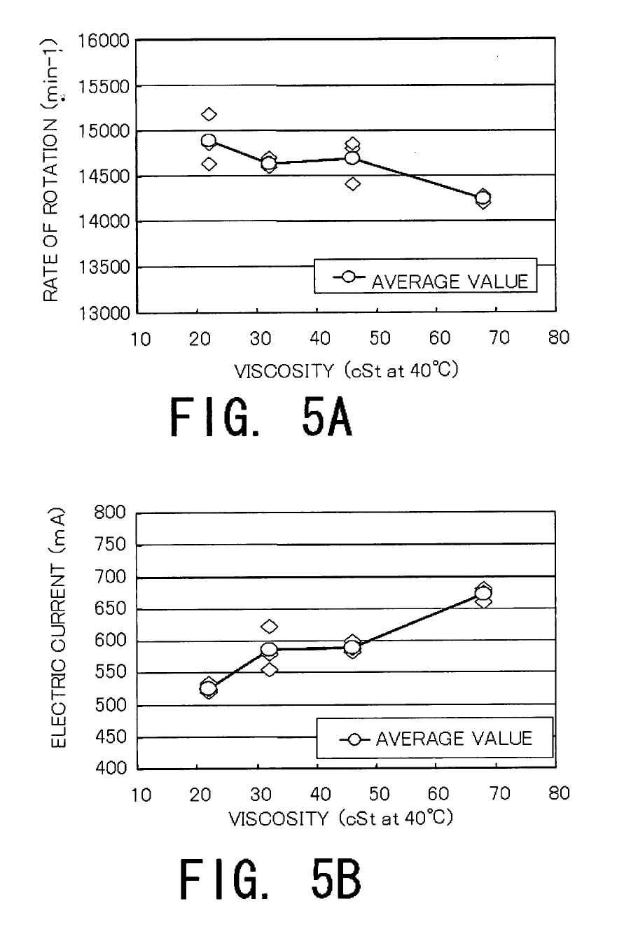

FIGS. 5A and 5B each indicate a graph indicating a result of a performance test similar to those shown in FIGS. 4A and 4B, wherein the degree of viscosity of the oil used therein is between approximately 22 and approximately 70.

According to FIG. 5A, a line showing an average value of the rate of rotation of the bearing mechanism 1 when oil having a greater viscosity is used declines toward the right hand side of the graph. That is, the greater the degree of viscosity of the oil used therein the smaller the rate of rotation of the bearing mechanism. Also, according to FIG. 5B, a line showing an average value of the electric current of the bearing mechanism when oil having greater viscosity is used shows a greater value toward the right hand side of the graph. That is, the greater the degree of the viscosity of the oil used therein the greater the value of electric current becomes, which means that the performance of the bearing mechanism is deteriorated.

As described above, according to FIGS. 5A and 5B, when the degree of viscosity of the oil used therein is 22, the motor performs appropriately and the oil will neither be scattered, degraded, nor evaporated, and therefore, the operating life of the motor will be extended.

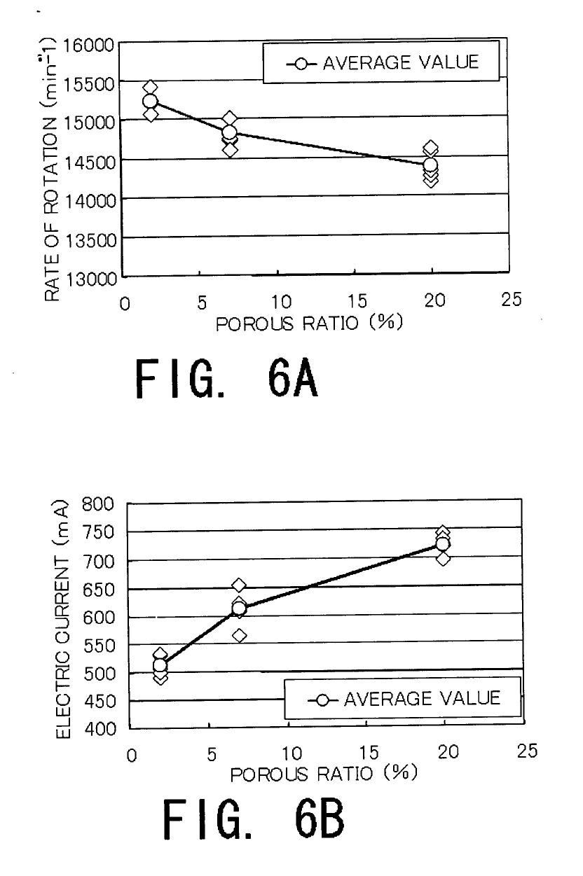

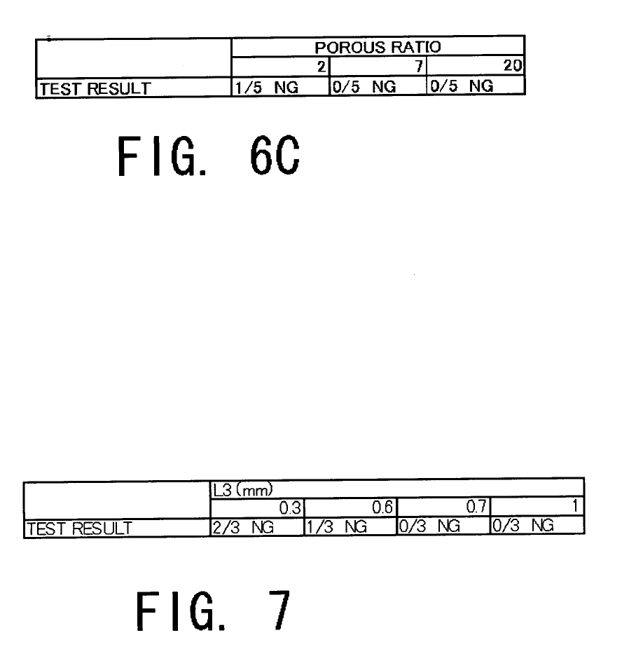

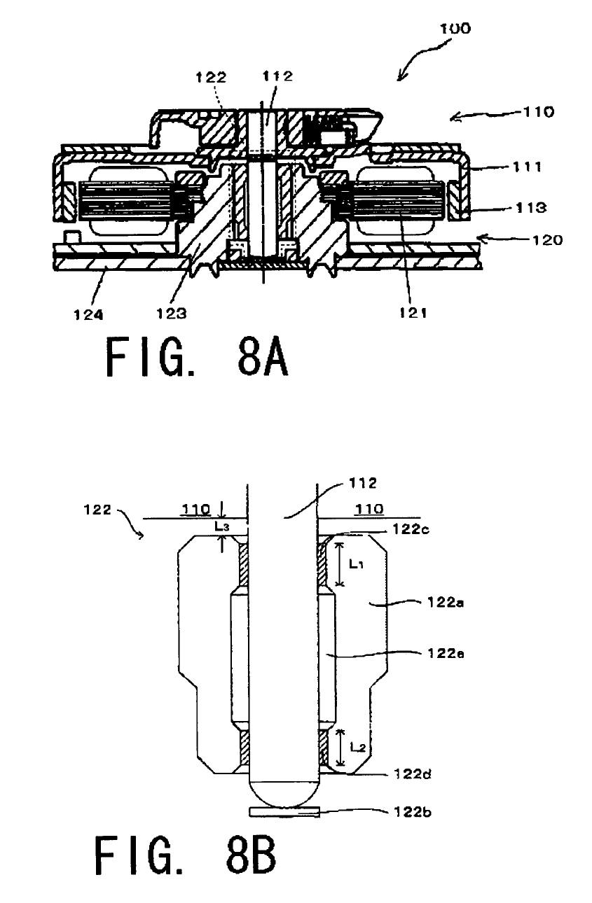

FIG. 6A to FIG. 6C each show a result of a performance test and that of the life evaluation test. FIG. 6A shows a correlation between the rate of rotation of the bearing mechanism and the porous ratio. FIG. 6B shows a correlation between the value of the electric current and the porous ratio.

According to FIG. 6A, it is evident that the smaller the porous ratio is the greater the rate of rotation of the bearing mechanism. According to FIG. 6B, it is evident that the smaller the porous ratio is the smaller the value of electric current is. That is, when the porous ratio is decreased the performance of the motor is improved.

FIG. 6C shows a result of the life evaluation test performed on the bearing mechanism 1 according to the present preferred embodiment of the present invention. In particular, FIG. 6C indicates a frequency of bearing mechanism failing the life evaluation test at given porous ratios.

According to FIG. 6C, when the porous ratio of the bearing mechanism 1 is approximately 2%, one out of five bearing mechanism 1 failed the life evaluation test, while the porous ratio is approximately 7% and approximately 20%, no bearing mechanism failed the life evaluation test. That is, when the porous ratio is 2%, the operating life of the motor is greatly affected.

Therefore, when the porous ratio is set between approximately 5% to approximately 15%, a film is easily formed on the oil surface compared with a conventional bearing mechanism thereby reducing an area of the direct contact between metal components.

By virtue of such configuration, the characteristics of the motor will be improved while extending the operating life of the motor.

FIG. 7 shows a result of the life evaluation test performed on the bearing mechanism 1 according to the present preferred embodiment of the present invention. In particular, FIG. 7 shows a frequency of the bearing mechanism 1 failing the life evaluation test with respect to L3, the between the bottom surface of the rotor 3 and the top surface of the sleeve 1a.

According to FIG. 7, when the space between the top surface of the sleeve 1a and the bottom facing surface of the rotor 3 is approximately 0.3 mm, two out of three bearing mechanisms failed the life evaluation test. While the space between the top surface of the sleeve 1a and the bottom facing surface of the rotor 3 is approximately 0.6 mm, one out of three bearing mechanisms failed the life evaluation test. Further, when the space between the top surface of the sleeve 1a and the bottom facing surface of the rotor 3 is approximately 0.7 mm or approximately 1 mm, no bearing mechanism failed the life evaluation test. That is, the shorter the space between the top surface of the sleeve 1a and the bottom facing surface of the rotor 3 in the axial direction is the shorter the operating life of motor is.

Therefore, it is preferable that the space between the top surface of the sleeve 1a and the bottom facing surface of the rotor 3 in the axial direction is greater than approximately 1 mm such that the oil arranged near the first bearing surface 1c will not adhere to the rotor 3 via the shaft 2, and further such that the oil will not be scattered due to centrifugal force of the rotor 3. Also, since the oil will be maintained appropriately in the bearing mechanism 1 according to the present preferred embodiment of the present invention, the operating life of the motor will be extended.

Further, it is to be appreciated that the space between the top surface of the sleeve 1a and the bottom facing surface of the rotor 3 in the axial direction is preferably approximately 1.0 mm since if the space is greater than approximately 1.0 mm stability of the shaft may be compromised (i.e., inclined).

As described above, with the bearing mechanism according to the present preferred embodiment of the present invention it becomes possible to provide a spindle motor used in a disk driving device having the same to have an extended operating life.

While the invention has been described in detail, the foregoing description is in all aspects illustrative and not restrictive. It is understood that numerous other modifications and variations can be devised without departing from the scope of the invention.

What is claimed is:

1. A bearing mechanism for use in a spindle motor for rotating a storage medium, the bearing mechanism comprising:
a shaft; and
a sleeve of hollow cylindrical shape into which the shaft is inserted, the sleeve in a concentric manner relatively rotating with respect to the shaft having an outer circumferential surface arranged to oppose an inner circumferential surface of the sleeve, wherein
the inner circumferential surface includes:
a first bearing surface arranged at an upper portion of the inner circumferential surface of the sleeve, arranged to oppose the outer circumferential surface of the shaft and having an axial length between substantially 1.2 mm to substantially 1.8 mm;
a second bearing surface arranged at a lower portion of the inner circumferential surface of the sleeve and arranged to oppose the outer circumferential surface of the shaft; and
a relief portion arranged at a portion between the first bearing surface and the second bearing surface, and having a radius greater than a radius of the first bearing surface and a radius of the second bearing surface.

2. The bearing mechanism according to claim 1, wherein the sleeve is a porous member and the first bearing surface includes at a surface thereof a porous ratio between substantially 5% to substantially 15%.

3. The bearing mechanism according to claim 1, wherein the sleeve is composed of, approximately, 30% to 70% iron, 30% to 70% copper, 3% to 7% tin, and 0.3% to 2% graphite.

4. The bearing mechanism according to claim 1, wherein the second bearing surface has an axial length between substantially 1.2 mm to 1.8 mm.

5. The bearing mechanism according to claim 4, wherein the sleeve is a porous member and the second bearing surface includes at a surface thereof a porous ratio between substantially 5% to substantially 15%.

6. The bearing mechanism according to claim 1, wherein
a rotor of a disk shape is arranged an upper portion of the shaft, and
a space between a bottom surface of the rotor and a top surface of the sleeve is greater than 1.0 mm.

7. The bearing mechanism according to claim 1, wherein hydrocarbon oil having a viscosity between substantially 22 cst and substantially 46 cst at 40° C. is provided at a space between the outer circumferential surface of the shaft and the first bearing surface and the outer circumferential surface of the shaft and the second bearing surface.

8. The bearing mechanism according to claim 1, wherein the first bearing surface and the second bearing surface slidably support the outer circumferential surface of the shaft.

9. A spindle motor used to rotate a storage medium comprising:
a rotor;
a stator; and
the bearing mechanism according to claim 1 arranged to support the rotor.
